(19) United States
(12) Patent Application Publication
(10) Pub. No.: US 2008/0065699 A1
(43) Pub. Date: Mar. 13, 2008

(54) SYSTEM AND METHOD FOR COLLECTION AND SYNCHRONIZATION OF METADATA TO FACILITATE DISTRIBUTED CONTENT SEARCH

(76) Inventors: L. Scott Bloebaum, Cary, NC (US); Mark G. Kokes, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/531,300

(22) Filed: Sep. 13, 2006

(51) Int. Cl. G06F 17/30

(52) U.S. Cl. 707/200

(57) ABSTRACT

A distributed content search system comprises a synchronization component, a distributed content search database, and a distributed content search component. The synchronization component receives, from each of a plurality of participating devices: i) identification of at least one content item being obtainable from the participating device; and ii) metadata associated with the subject of the at least one content item. The distributed content search database associates: i) identification of the participating device from which the content item is obtainable; and ii) the metadata associated with the subject of the content item. The distributed content search component receives a search query input from a querying device and returns search results. The search results comprise, for each of a plurality of instances of relevant distributed content, a link to the participating device form which the relevant distributed content is obtainable. Each of the plurality of instances of relevant distributed content is a one of the instances of content that is associated, by the distributed content search database, with metadata which corresponds to the search query input.

### TECHNICAL FIELD OF THE INVENTION

The present invention relates to systems and methods for implementing distributed content search functions and, in particular, systems and methods for collecting and synchronizing metadata for facilitating distributed content search functions.

### DESCRIPTION OF THE RELATED ART

Internet search engine technology has been generally available for several years. Typical Internet search engine providers utilize web crawler technology to categorize documents which are available at publicly accessible URL's. Categorizing each document may include developing metadata defining the subject matter of the document. The search engine provider stores the metadata in a searchable database. When a search query is obtained from a client, the metadata is searched to locate documents with subject matter related to the search query. A listing of links to such documents is returned to the client.

More recently, certain search engine providers have offered a local search engine software product for searching documents and files stored locally on a computer system, such as a desk top computer or notebook computer. The local search engine software is an executable program which is installed on the computer system and, when launched, executes from the computer system's local memory.

More specifically, a crawler component (executed locally) categorizes the documents which are stored on the computer's hard drive and builds a searchable metadata database. When a user launches a search query component (also executed locally) and enters a search query, such search query component will search the metadata database and return a listing of links to the locally stored documents or files relevant to the search query.

In a separate and distinct field of technology, providers of portable radio communication equipment, including mobile telephones, portable data assistants (PDAs), and other mobile electronic devices have added Internet data connectivity to such equipment. Internet data connectivity has enabled wide area network (WAN) service providers, such as mobile telephone service providers, to offer Internet browsing capabilities, email capabilities, text messaging capabilities, downloadable ring tone capabilities, downloadable MP3 music file capabilities, and similar Internet based services on portable radio communication equipment operating on their networks.

It is recognized that utilizing search capabilities with portable radio communication would be useful. However, utilizing traditional local and/or remote search engine technology as discussed above has several drawbacks.

First, while the full QWERTY keyboard and full size display screen of a typical desktop or notebook computer makes navigating web links to locate a remote search engine provider's website (and/or launching a local search engine software) and entering a search query quite easy, the limited display size, limited display resolution, and limited keyboard capability of typical portable radio device makes the task cumbersome. Further, while it has been proposed to capture a segment of speech or other audio as input to a search query, such input does not reduce the complexity of using the user interface of the typical portable radio device to navigate the internet to a search engine provider's website.

Secondly, because the processing power available on typical portable radio communication equipment is limited, the devices ability to execute local search engine software is limited. If local search engine software were installed on typical portable radio communication equipment, its processing requirements would make operation slow and it could significantly reduce battery life.

Thirdly, due to cost, size and other considerations, the amount of non-volatile memory available on typical portable radio communication equipment is quite small, which limits the amount of content that can be physically stored on such equipment. In particular, only a small fraction of the documents, files, or other media available to a user on his or her desktop/notebook computer are able to be stored locally on his or her portable radio communication equipment. As such, even if local search engine capabilities were added to the portable radio communication equipment, search results would be limited to locally stored documents, files, and other media.

What is needed is a system and method for providing search functions of content distributed across multiple systems. In more detail what is needed is a system and method for collecting and synchronizing metadata for facilitating the search of content distributed across multiple systems.

### SUMMARY

A first aspect of the present invention comprises a distributed content search system for providing efficient search capabilities for obtaining relevant (and authorized) content available from multiple disparate participating devices.

The distributed content search system comprises a synchronization component, a distributed content search database, and a distributed content search component.

The synchronization component receives, from each of a plurality of participating devices: i) identification of at least one instance of multi-media content being obtainable from the participating device; and ii) metadata associated with the subject of the at least one instance of multi-media content.

The distributed content search database associates, for each of the plurality of instance of multi-media content: i) identification of the participating device from which the instance of multi-media content is obtainable; and ii) the metadata associated with the subject of the instance of multi-media content.

The distributed content search component receives search query input form a querying device and returns search results. The search results comprise, for each of a plurality of instances of relevant distributed content, a link to the participating device form which the relevant distributed content is obtainable.

Each of the plurality of instances of relevant distributed content is a one of the instances of multi-media content that is associated, by the distributed content search database, with metadata which corresponds to the search query input.

Further, to keep the distributed content search database updated, the synchronization component may further receive, from each of the participating devices, at least one of: i) identification of an additional instance content being obtainable from the participating device and metadata associated with the subject of the additional instance of multi-media content; and ii) identification of an instance of multi-media content no longer obtainable from the participating device. Upon receipt the synchronization may update the contents of the distributed content search database.

In one sub-embodiment, the distributed content search database may further associate, for each of the plurality of instances of multi-media content, authorization rules identifying credentials that are authorized to access the instance of multi-media content. In such sub-embodiment, each of the plurality of instances of relevant distributed content is a one of the instances of multi-media content that is associated, by the distributed content search database: i) with metadata which corresponds to the search query input; and ii) authorization rules which authorize access to the instance of multi-media content by the querying device.

Further, in such sub-embodiment, the authorization rules may authorize access to the instance of multi-media content by the querying device if the authorization rules identify a credential value corresponding to a one of: i) a user identification value associated with the user of the querying device; ii) a device identification value associated with the querying device; and iii) a group identification value associated with a group of identification values, the identification values comprising at least one of user identification values and device identification values. This function enables the owner of the multi-media content stored on any participating device to restrict access to such multi-media content to only certain authorized users or authorized devices.

In another sub-embodiment, the distributed content search component further receives public search results from a remote database. In such sub-embodiment, the search results provided to the querying device further include the public search results. The public search results include, for each of a plurality of instances of relevant public content that associates with the search query input, a link to the relevant public content.

In any of such embodiments, the search query input received from the querying device may comprise an audio segment of speech or other audio representing a search query input phrase. As such, the distributed content engine may derive a search query from the audio segment and the metadata which corresponds to the search query input is metadata which corresponds to the search query derived from the audio segment.

A second aspect of the present invention is to provide a method of operating a distributed content search system for returning search results to a querying device. The method may comprise receiving, from each of a plurality of participating devices: i) identification of at least one instance of multi-media content being obtainable from the participating device; and ii) metadata associated with the subject of the at least one instance of multi-media content.

The method further comprises building a distributed content search database which integrates the metadata received from multiple participating devices. The distributed content search database associates, for each of the plurality of instances of multi-media content: i) identification of the participating device from which the instance of multi-media content is obtainable; and ii) the metadata associated with the subject of the instance of multi-media content.

A search query input is received from the querying device and search results are returned. Again, the search results comprise, for each of a plurality of instances of relevant distributed content, a link to the participating device form which the relevant distributed content is obtainable. Again, each of the plurality of instances of relevant distributed content may be one of the instances of multi-media content that is associated, by the distributed content search database, with metadata which corresponds to the search query input.

To keep the distributed content search database synchronized with the multi-media content obtainable from each participating device, the method may further comprise receiving, from each of the participating devices, at least one of: i) identification of an additional instance content being obtainable from the participating device and metadata associated with the subject of the additional instance of multi-media content; and ii) identification of an instance of multi-media content no longer obtainable from the participating device. Upon receipt the distributed content search database may be updated.

Again, in one sub-embodiment, the distributed content search database may further associate, for each of the plurality of instances of multi-media content, authorization rules identifying credentials that are authorized to access the instance of multi-media content. In such sub-embodiment, each of the plurality of instances of relevant distributed content is a one of the instances of multi-media content that is associated, by the distributed content search database: i) with metadata which corresponds to the search query input; and ii) authorization rules which authorize access to the instance of multi-media content by the querying device.

Again, in such sub-embodiment, the authorization rules may authorize access to the instance of multi-media content by the querying device if the authorization rules identify a credential value corresponding to a one of: i) a user identification value associated with the user of the querying device; ii) a device identification value associated with the querying device; and iii) a group identification value associated with a group of identification values, the identification values comprising at least one of user identification values and device identification values.

In another sub-embodiment, public search results may be received from a remote database. The public search results include, for each of a plurality of instances of relevant public content that associates with the search query input, a link to the relevant public content. In such sub-embodiment, the search results returned to the querying device further comprise the public search results.

Again, in any of such embodiments, the search query input received from the querying device may comprise an audio segment of speech or other audio representing a search query input phrase. As such, a search query may be derived from the audio segment and the metadata which corresponds to the search query input is metadata which corresponds to the search query derived from the audio segment.

With specific respect to the participating device an aspect of the present invention comprises a mobile network device for interacting with a distributed content search database. The mobile network device comprises a content storage for storing a plurality of multi media content items. A distributed content participation module comprises a metadata module and a search module.

The metadata module: i) stores, for each of a plurality of content items, metadata describing the content item; and ii) sends the locally stored metadata to a distributed content search system. Further, the metadata module may periodically provides updates of locally stored metadata to the distributed content search system. The updates comprising at least one of: i) identification of an additional content item being obtainable from the participating device and metadata associated with the subject of the additional content item; and ii) identification of a content item no longer obtainable from the participating device.

The search module: i) obtains a search query input; ii) sends the search query input to the distributed content search system, and iii) receives search results from the distributed content search system. The search query input may be text or an audio segment of spoken words captured by the mobile network device.

The search results comprise, for each of a plurality of relevant distributed content items, a link to a one of a plurality of participating devices from which the relevant distributed content item is obtainable.

In one sub-embodiment, the metadata module further provides authorization rules governing access to a content item to the distributed content search system. The authorization rules may identify a credential value corresponding to a one of: i) a user identification value associated with the user of the querying device; ii) a device identification value associated with the querying device; and iii) a group identification value associated with a group of identification values, the identification values comprising at least one of user identification values and device identification values.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a diagram representing exemplary architecture for operation of a distributed content search system in accordance with an embodiment of the present invention;

FIG. 2 is a diagram representing an exemplary distributed content search system in accordance with an embodiment of the present invention; and

FIG. 3 is a ladder diagram representing exemplary operation of a distributed content search system in accordance with an embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

Table and/or database structures represented in this application are exemplary only and intended to show the mapping of relationships between various data elements. Those skilled in the art will recognize that other table and/or database structures may store similar data elements in a manner that maintains the relationships useful for the practice of the present invention without departing from the scope of the present invention.

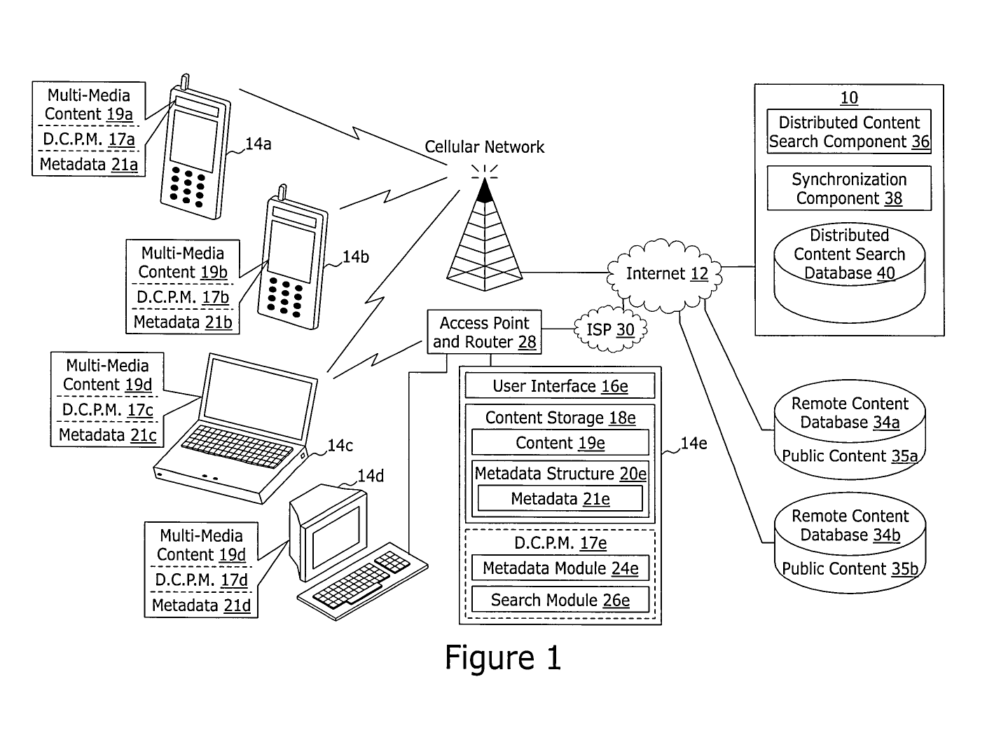

With reference to FIG. 1, the present invention comprises a distributed content search system 10 which interoperates with a plurality of participating devices 14a-14e. The distributed content search system 10 may include a distributed content search component 36, a synchronization component 38, and a distributed content search database 40 to synchronize and integrate searchable metadata representing the subject matter of searchable multi-media content items 19a-19e obtainable from each of the plurality of participating devices 14a-14e.

In operation, the distributed content search system 10 enables each of the participating devices 14a-14e to search and obtain multi-media content items 19a-19e accessible through each of the other participating devices 14a-14e. Further, the distributed content search system 10 enables each participating device 14a-14e to search and obtain public content 35a and 35b from a plurality of remote content database 34a and 34b.

In the exemplary embodiment, each participating device 14a-14e may be any of: i) a mobile radio terminal such as a mobile telephone (represented by reference numeral 14a), wireless data device such as a PDA (represented by reference numeral 14b), a portable computer with wide area network communication capabilities (represented by reference numeral 14c) or any other mobile radio terminal with capabilities of establishing data connections for the exchange of data with remote devices over a wide area wireless network 32; or ii) a networked computing system such as a portable computer with wireless or wired networking capabilities (represented by reference numeral 14c), a desk top computer with wireless or wired networking capability (represented by reference numeral 14c), or any other computing systems with capabilities of establishing data connections for the exchange of data with remote devices though an network connection 28 to an Internet Service Provider network 30.

Each of the participating devices 14a-14e may store multi-media content items 19a-19e such as document files, spread sheet files, ring tones, songs or other audio and/or audio visual clips, image files, games, or other application data files. The multi-media content may be stored in a content storage 18 (for simplicity only the content storage 18e of participating device 14e is shown). The content storage 18 may be any of a disk drive, flash memory, or other known storage media, local or remote, accessible on or by the participating device 14.

Each participating device 14a-14e may also include a distributed content participation module 17a-17e. Each participation module 17a-17e may include a metadata module 24 (for simplicity only the metadata module 24e of participating device 14e is shown). The metadata module 24 executes on the participating device 14 and stores, for each content item 19 accessible from the content storage 18, metadata 21 which describes the subject matter of the content item 19. Such metadata 21 is stored in a local metadata structure 20 on the participating device 14 (for simplicity only the metadata structure 20e of participating device 14e is shown).

The metadata module 24 also periodically sends the locally stored metadata 21 to the synchronization component 38 of the distributed content search system 10 such that the metadata stored in the distributed content search database 40 remains synchronized to the metadata obtainable from the participating device 14.

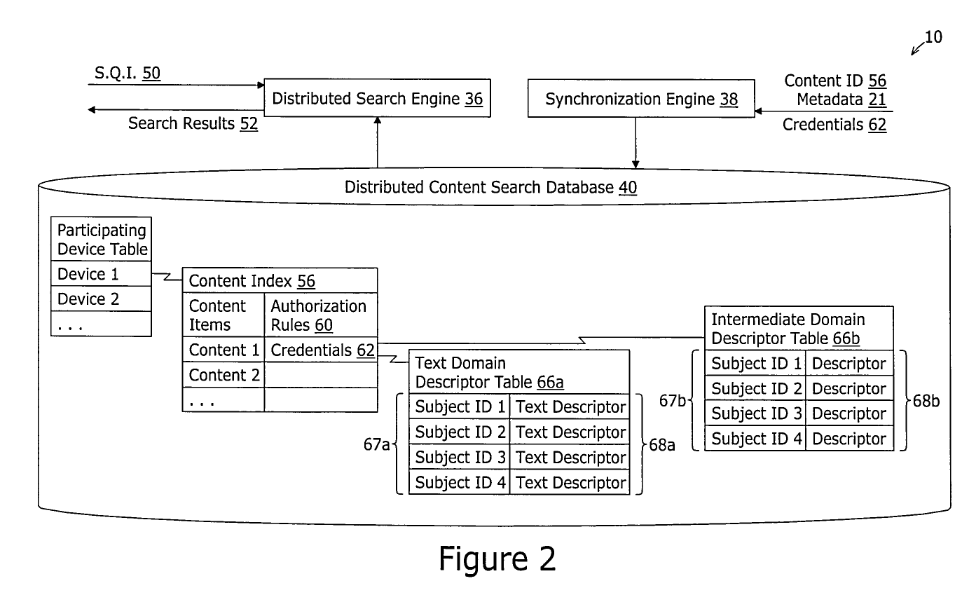

Those skilled in the art will recognize that there exist many systems, methods, and structures for implementing a search of multi-media content and the particular implementation chosen is a matter of design choice. For purposes of enabling the present invention one exemplary embodiment is represented by the block diagram of FIG. 2. Referring to FIG. 2 in conjunction with FIG. 1, in this exemplary structure, content items 19 stored on any of the participating devices 14 is referenced by a content index 56 associated with the participating device 14 on which the content item 19 is stored or otherwise accessible.

The content index 56 associates the content item 19 with any combination of one or more of a file identifier, URL, IP address (IPv4, IPv6), another network address identifier, and/or a directory path that facilitates access to the content item 19.

Each content index 56 is associated with content descriptors in one or more search domains. A first exemplary search domain may be a text based domain. To enable searching in the text based domain, a text domain descriptor table 66a associates predefined subject identifiers 67a with text descriptors 68a (text based metadata) describing the content item 19. For example, if the content item 19 is an MP3 file, the subject identifiers 67a may include song title, name of artist, genre, etc.

A second exemplary search domain may be an intermediate based domain. In one example a search query input 50 may be received in the form of a sequence of compressed audio and the search domain may be a compressed audio domain. To enable searching in the compressed audio domain, a compressed audio domain descriptor table 66b associates predefined subject identifiers 67b with compressed audio descriptors 68b describing the content item 19. The compressed audio descriptors 68b may be data representing descriptive features of an audio (e.g. spoken) representation of the text domain based descriptors 68a. The descriptive features can be any of the parameters typically used for compressing raw audio (pitch, energy, formant coefficients, etc). Again for example, if the content item 19 is an MP3 file, the subject identifiers 67b may include song title, name of artist, genre, etc. and the corresponding compressed audio descriptors 68b may be descriptive features of audio representing a spoken articulation (real speaker or synthesis) name of the song title, name of the artist, genre, etc.

In operation, the metadata synchronization module 24 of each participating device provides an index of its locally stored content items 19 and the locally stored metadata 21 representing the subject matter of such content items 19 to a synchronization component 38 of the distributed content search system 10. Further, the metadata synchronization module 24 of each participating device updates such metadata 21 when content items 19 are added to, or removed from, the content storage 18 of the participating device 14.

The synchronization component 38 aggregates the metadata 21 provided by each participating system 14 in the distributed content search database 40 and, when possible, converts the metadata 21 to other search domains. In more detail, the synchronization component 38: i) populates text domain descriptor table 66a with text descriptors 68a for facilitating search in the text domain; and ii) when possible, populates the intermediate domain descriptor table 66b with descriptors derived by converting the text based descriptors 68a to the intermediate domain descriptors 68b. In the example wherein the intermediate domain descriptors 68b are a compressed audio representation of a speaker articulating the corresponding text based metadata, the synchronization component 38 may utilize a combination of voice synthesis technology and audio compression technology to generate the descriptive features.

In one sub-embodiment, each content item 19 stored on any of the participating devices 14 may also be associated, in the distributed content search database 40, with authorization rules 60 identifying credentials 62 which are authorized to access the instance of multi-media content 19. The credentials 62 may identify any of: i) a user identification value; ii) a device identification value or iii) a group identification value associating with, or identifying, a group of one or more user identification values and/or device identification values. Only those users and/or participating devices 14 with a user ID and/or device ID that corresponds to the credentials 62 may access the content item 19.

In this embodiment, the participating device 14 through which content item 19 is accessible may provide the credentials 62 to the synchronization component 38. The synchronization module 38 stores the credentials 62 in the database 40.

A search module 26 (for simplicity only the search module 26e of participating device 14e is shown) enables a user of a participating device 14 to search for: i) content 19 stored on any of the participating devices 14; and ii) public content 35a-35b stored on a remote content database 34a-34b by generating a search query input 50 to the distributed content search component 36 of the distributed content search system 10. The search query input 50 may be a text string or an audio segment (representing spoken audio) captured by the participating device 14.

The distributed content search component 36 searches the descriptor database tables 66a, 66b that are of a domain compatible with the search query input 50 and any descriptor database tables 66a, 66b that are of a domain compatible with a domain into which the search query input 50 can be converted to obtain search results 52.

For example, if the search query input 50 is a text string, the distributed content search component 36 may search the text domain descriptor table 66a to identify relevant content items 19. The search component 36 may further generate queries to remote content databases 34a, 34b to obtain a link to each instance of relevant public content 35a, 35b available from one of the remote content database 34a, 34b. Such results 52 are integrated by the distributed content search component 36.

If the search query input 50 is an audio segment, the distributed content search component 36 may search the intermediate domain descriptor table 66b to identify relevant content items 19. Exemplary matching of an audio segment to intermediate domain descriptors may include utilizing known technology for time domain normalization of the audio segment to a potentially matching intermediate domain descriptor (to correct for speaking speed discrepancies) and measuring the parameters of the normalized audio segment for matching against the intermediate domain descriptors using known matching algorithms.

Further, if the search component 36 includes capabilities for converting the search query input 50 to the text domain, the search component both: i) search the text domain descriptor table 66a to identify relevant content items 19; and ii) generate queries to remote content databases 34a, 34b to obtain a link to each instance of relevant public content 35a, 35b available from one of the remote content database 34a, 34b. Again, such results 52 are integrated by the distributed content search component 36.

Further, in the sub-embodiment wherein authorization rules are used to restrict access to certain content items 19, the search results 52 are restricted to only those content items 19 that are both relevant and authorized. A content item 19 is considered authorized only if the user ID and or device ID of the participating device 14 generating the search query input 50 corresponds to one of the credential values 64 of the credentials 62 associated with the content index 56 of such content 19.

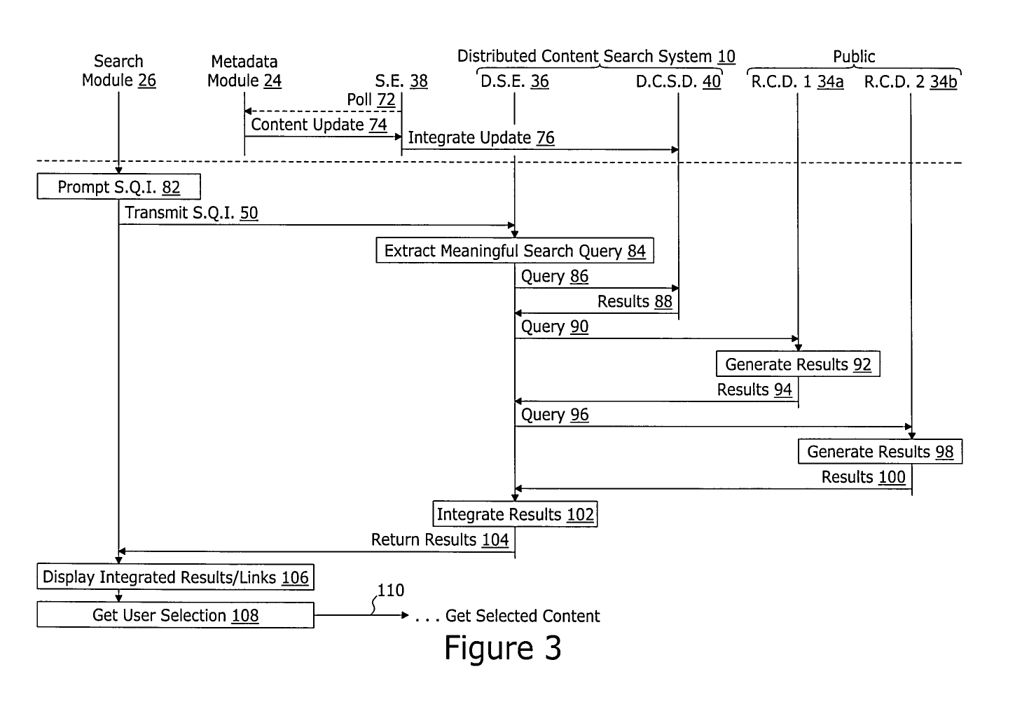

The ladder diagram of FIG. 3 represents a more detailed operation of the distributed content search system 10. Steps 72 through 76 represent interaction between the synchronization module 24 of each participating device 14 and the synchronization component 38 of the distributed content search system 10 for: i) collecting and synchronizing metadata associated with searchable multi-media content items 19 obtainable from each participating device 14; and ii) integrating such metadata in the distributed content search database 40. Steps 82 through 110 represent interaction between the search module 26 of a querying device and the distributed content search component 38 of the distributed content search system 10 for enabling a user of the querying device to search and obtain integrated search results representing content available from each of the other participating devices and/or the remote content database 34a-34b.

Turning to FIG. 3 in conjunction with FIG. 2, the metadata module 24 periodically provides content update messages (represented by step 74) to the synchronization component 38. The content update message may be generated in response to the metadata module 24 updating the metadata 21 stored on the participating device 14 or may be generated in response to a polling message sent by the synchronization component 38 (represented by step 72).

Each content update message may include identification of new content items 19 obtainable from the participating device 14 and/or identification of content items 19 no longer obtainable from the participating device 14. Further, the message may include updates to metadata 21 reflecting the new content or the content no longer available. Further yet, the message may include updates to authorization credentials 62 associated with content items 19 obtainable from the participating device 14.

The synchronization component writes the updated content descriptors (in each of the multiple domains) to the distributed content search database 40 to maintain its synchronization with the participating device. The authorization credentials 62 are also updated for content items 19 for which the authorization credentials 62 have been changed.

Step 82 represents the search module 26 of a participating device 14 initiating the search (referred to as the querying device) prompting the user to enter a search query input. As discussed, the search query input may be text or an audio segment representing spoken audio. The search query input 50, whether text or audio segment, is transmitted to the distributed search component 36 of the distributed content search system 10 as indicated by step 50.

The distributed content search component 36 generates a meaningful search query for at least one of the search domains from the search query input 50 as indicated by step 84. In an example wherein the search query input 50 is a text string, generating a meaningful search query may include identifying those portions of the text string which may be mapped to, or scored against, the descriptors of the text descriptors 68a of the predefined subjects 67a of the text domain descriptor table 66a. In an example wherein the search query input 50 is an audio segment, generating a meaningful search query may include identifying those portions of those portions of the audio segment which may be mapped to, or scored against, the intermediate domain descriptors 68b of the predefined subjects 67b of the intermediate descriptor table 66b and, if possible, converting the search query input 50 to the text domain and identifying those portions that can be mapped to, or scored against, the text descriptors 68a of the predefined subjects 67a of the text domain descriptor table 66a.

The distributed content search component 36 queries the distributed content search database 40 at step 86 to obtain (at step 88) identification of relevant content items 19, which may be stored on any of the participating devices 14a-14e. Relevant content items are content items wherein its content descriptors 68a, 68b in one of the descriptor tables 66a, 66b relate to the meaningful search query.

As discussed, only links to content items 19 that are authorized to be accessed by the querying device may be returned as part of the search results. In more detail, the querying device is authorized to access the content item 19 if one of its device ID or user ID corresponds to the credentials 62 associated with the content item 19 in the authorization rules 60. Relevant search results which are not authorized may be filtered out.

The distributed search component 36 may further query and obtain public search results from one or more remote content database 34a and 34b as represented by steps 90 through 96. Steps 90 through 96 may represent transmitting the meaningful search query (in the text domain) to one or more traditional public search engines and obtaining results there from in a traditional manner.

Step 102 represents integrating the search results obtained from the distributed content search database 40 with the public results obtained from the remote content databases 34a, 34b to generate search results to return to the querying device at step 104. Integration may including listing the results based on relevance to the search query input.

Step 106 represents display, on the user interface 16 of the querying device, a link to each instance of multi-media content (whether public content identified by one of the remote content database 34a, 34b or distributed multi-media content 19 stored on one of the participating device 14) identified by the distributed content search component 36.

Step 110 represents the querying device obtaining the content in response to user selection of one of the links that was returned as part of the search results at step 106.

Returning to FIG. 1, it should be appreciated that the exemplary structures and methods discussed herein provide efficient search capabilities for obtaining relevant (and authorized) content available from multiple disparate participating devices. Although the invention has been shown and described with respect to certain preferred embodiments, it is obvious that equivalents and modifications will occur to others skilled in the art upon the reading and understanding of the specification.

For example, the distributed search component 36, the synchronization component 38, and the distributed content search database 40 represents a grouping of logical functions relevant to implementing the present invention. Those skilled in the art will recognize that each such grouping of functions may be operated on one or more hardware servers. As such, the functions of each of the distributed search component 36, the synchronization component 38, and the distributed content search database 40 may operate on a single hardware server be distributed across hardware multiple servers. Further, if such functions are distributed across multiple hardware servers, the distribution of functions amongst the servers is a matter of design choice. Those skilled in the art will recognize that the delineation of functions across multiple servers may vary from the delineation of functions amongst the distributed search component 36, the synchronization component 38, and the distributed content search database 40.

The present invention includes all such equivalents and modifications, and is limited only by the scope of the following claims.

1. A distributed content search system comprising:
a synchronization component receiving, from each of a plurality of participating devices:
identification of at least one content item being obtainable from the participating device; and
metadata associated with the subject of the at least one content item;
a distributed content search database associating, for each of the plurality of instances of content:
identification of the participating device from which the content item is obtainable;
the metadata associated with the subject of the content item; and
a distributed content search component:
receiving a search query input from a querying device; and
returning search results to the querying device, the search results comprising, for each of a plurality of instances of relevant distributed content, a link to the participating device form which the relevant distributed content is obtainable;
wherein each of the plurality of instances of relevant distributed content is a one of the instances of content that is associated, by the distributed content search database, with metadata which corresponds to the search query input.

2. The distributed content search system of claim 1, wherein:
the distributed content search database further associates, for each of the plurality of instances of content, authorization rules identifying credentials that are authorized to access the content item; and
each of the plurality of instances of relevant distributed content is a one of the instances of content that is associated, by the distributed content search database:
with metadata which corresponds to the search query input; and
authorization rules which authorize access to the content item by the querying device.

3. The distributed content search system of claim 2, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

4. The distributed content search system of claim 1, wherein the synchronization component further receives, from each of the participating devices, at least one of:
i) identification of an additional instance content being obtainable from the participating device and metadata associated with the subject of the additional content item; and
ii) identification of a content item no longer obtainable from the participating device; and
updating the distributed content search database.

5. The distributed content search system of claim 4, wherein:
the distributed content search database further associates, for each of the plurality of instances of content, authorization rules identifying credentials that are authorized to access the content item; and
each of the plurality of instances of relevant distributed content is a one of the instances of content that is associated, by the distributed content search database:
with metadata which corresponds to the search query input; and
authorization rules which authorize access to the content item by the querying device.

6. The distributed content search system of claim 5, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

7. The distributed content search system of claim 1, wherein:
the distributed content search component further receives public search results from a remote database, the public search results including, for each of a plurality of instances of relevant public content that associates with the search query input, a link to the relevant public content; and
the search results further comprise the public search results.

8. The distributed content search system of claim 7, wherein:
the distributed content search database further associates, for each of the plurality of instances of content, authorization rules identifying credentials that are authorized to access the content item; and
each of the plurality of instances of relevant distributed content is a one of the instances of content that is associated, by the distributed content search database:
with metadata which corresponds to the search query input; and
authorization rules which authorize access to the content item by the querying device.

9. The distributed content search system of claim 8, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

10. The distributed content search system of claim 7, wherein the synchronization component further receives, from each of the participating devices, at least one of:
i) identification of an additional instance content being obtainable from the participating device and metadata associated with the subject of the additional content item; and
ii) identification of a content item no longer obtainable from the participating device; and updating the distributed content search database.

11. The distributed content search system of claim 10, wherein:
the distributed content search database further associates, for each of the plurality of instances of content, authorization rules identifying credentials that are authorized to access the content item; and
each of the plurality of instances of relevant distributed content is a one of the instances of content that is associated, by the distributed content search database:
with metadata which corresponds to the search query input; and
authorization rules which authorize access to the content item by the querying device.

12. The distributed content search system of claim 11, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

13. The distributed content search system of claim 7, wherein:
the querying device is a mobile radio communication device;
receiving a search query input from a querying device comprises receiving an audio segment representing the user speaking a search query input phrase captured by the mobile radio communication device;
the distributed content engine derives a search query from the audio segment; and
the metadata which corresponds to the search query input is metadata which corresponds to the search query derived from the audio segment.

14. The distributed content search system of claim 13, wherein:
the distributed content search database further associates, for each of the plurality of instances of content, authorization rules identifying credentials that are authorized to access the content item; and
each of the plurality of instances of relevant distributed content is a one of the instances of content that is associated, by the distributed content search database:
with metadata which corresponds to the search query input; and
authorization rules which authorize access to the content item by the querying device.

15. The distributed content search system of claim 14, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

16. A method of operating a distributed content search system for returning search results to a querying device, the method comprising:
receiving, from each of a plurality of participating devices:
identification of at least one content item being obtainable from the participating device; and
metadata associated with the subject of the at least one content item;
associating, in a distributed content search database, for each of the plurality of instances of content:
identification of the participating device from which the content item is obtainable;
the metadata associated with the subject of the content item; and
receiving a search query input from the querying device; and
returning search results to the querying device, the search results comprising, for each of a plurality of instances of relevant distributed content, a link to the participating device form which the relevant distributed content is obtainable;
wherein each of the plurality of instances of relevant distributed content is a one of the instances of content that is associated, by the distributed content search database, with metadata which corresponds to the search query input.

17. The method of claim 16:
further associating, in the distributed content search database, for each of the plurality of instances of content, authorization rules identifying credentials that are authorized to access the content item; and
wherein each of the plurality of instances of relevant distributed content is a one of the instances of content that is associated, by the distributed content search database:
with metadata which corresponds to the search query input; and
authorization rules which authorize access to the content item by the querying device.

18. The method of claim 17, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

19. The method of claim 16, further comprising:
receiving, from each of the participating devices, at least one of:
i) identification of an additional instance content being obtainable from the participating device and metadata associated with the subject of the additional content item; and
ii) identification of a content item no longer obtainable from the participating device; and
updating the distributed content search database.

20. The method of claim 19:
further associating, in the distributed content search database, for each of the plurality of instances of content, authorization rules identifying credentials that are authorized to access the content item; and
wherein each of the plurality of instances of relevant distributed content is a one of the instances of content that is associated, by the distributed content search database:
with metadata which corresponds to the search query input; and
authorization rules which authorize access to the content item by the querying device.

21. The method of claim 20, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

22. The method of claim 16:
further receiving, public search results from a remote database, the public search results including, for each of a plurality of instances of relevant public content that associates with the search query input, a link to the relevant public content; and
the search results further comprise the public search results.

23. The method of claim 22:
further associating, in the distributed content search database, for each of the plurality of instances of content, authorization rules identifying credentials that are authorized to access the content item; and
wherein each of the plurality of instances of relevant distributed content is a one of the instances of content that is associated, by the distributed content search database:
with metadata which corresponds to the search query input; and
authorization rules which authorize access to the content item by the querying device.

24. The method of claim 23, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

25. The method of claim 12, further comprising:
receiving, from each of the participating devices, at least one of:
i) identification of an additional instance content being obtainable from the participating device and metadata associated with the subject of the additional content item; and
ii) identification of a content item no longer obtainable from the participating device; and
updating the distributed content search database.

26. The method of claim 25:
further associating, in the distributed content search database, for each of the plurality of instances of content, authorization rules identifying credentials that are authorized to access the content item; and
wherein each of the plurality of instances of relevant distributed content is a one of the instances of content that is associated, by the distributed content search database:
with metadata which corresponds to the search query input; and
authorization rules which authorize access to the content item by the querying device.

27. The method of claim 26, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

28. The method of claim 19, wherein:
the querying device is a mobile radio communication device;
receiving a search query input from a querying device comprises receiving an audio segment representing the user speaking a search query input phrase captured by the mobile radio communication device;
the method further comprises deriving a search query from the audio segment; and
the metadata which corresponds to the search query input is metadata which corresponds to the search query derived from the audio segment.

29. The method of claim 28:
further associating, in the distributed content search database, for each of the plurality of instances of content, authorization rules identifying credentials that are authorized to access the content item; and
wherein each of the plurality of instances of relevant distributed content is a one of the instances of content that is associated, by the distributed content search database:
with metadata which corresponds to the search query input; and
authorization rules which authorize access to the content item by the querying device.

30. The method of claim 29, wherein the authorization rules authorize access to the content item by the querying device if the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.

31. A mobile network device for interacting with a distributed content search, the mobile network device comprising:
a content storage for storing a plurality of multi media content items;
a distributed content participation module comprising
a metadata module for:
storing, for each of a plurality of content items, metadata describing the content item; and
sending the locally stored metadata to a distributed content search system;
a search module for:
obtaining a search query input;
sending the search query input to the distributed content search system,
receiving search results from the distributed content search system, the search results comprises, for each of a plurality of relevant distributed content items a link to a one of a plurality of participating devices from which the relevant distributed content item is obtainable.

32. The mobile network device of claim 32, wherein the metadata module further provides updates of locally stored metadata to the distributed content search system, the updates comprising at least one of:
i) identification of an additional content item being obtainable from the participating device and metadata associated with the subject of the additional content item; and
ii) identification of a content item no longer obtainable from the participating device.

33. The mobile network device of claim 2, wherein the metadata module further provides authorization rules governing access to a content item to the distributed content search system.

34. The mobile network device of claim 33, wherein the authorization rules identify a credential value corresponding to a one of:
a user identification value associated with the user of the querying device;
a device identification value associated with the querying device; and
a group identification value associated with a group of identification values, the identification values comprising at least one of user identification values and device identification values.
